(19) United States
(12) Patent Application Publication
(10) Pub. No.: US 2026/0195183 A1
(43) Pub. Date: Jul. 9, 2026

(54) ELECTRONIC DEVICE AND METHOD FOR RESOURCE MANAGEMENT

(71) Applicant: Samsung Electronics Co., Ltd., Suwon-si (KR)

(72) Inventors: Iksoon KIM, Suwon-si (KR); Kyungmin KANG, Suwon-si (KR); Changhyeon CHAE, Suwon-si (KR); Youngho CHOI, Suwon-si (KR)

(21) Appl. No.: 19/552,980

(22) Filed: Feb. 27, 2026

Related U.S. Application Data
(63) Continuation of application No. PCT/KR2024/013981, filed on Sep. 13, 2024.

(30) Foreign Application Priority Data
Sep. 19, 2023 (KR) 10-2023-0125016

(51) Int. Cl. G06F 9/50; G06F 3/14

(52) U.S. Cl. CPC G06F 9/5027; G06F 3/1454

(57) ABSTRACT

An electronic device: determines whether a first service associated with a first application and requested to be executed in a background satisfies a specified condition; based on the first service satisfying the specified condition, allocates the first service to a first control group from among a plurality of control groups; and allocates a resource to the first service on the basis of a first resource allocation ratio corresponding to the first control group, wherein the plurality of control groups include the first control group, a second control group including a second application executed in a foreground, and a third control group including a third service executed in the background, and the first resource allocation ratio may be smaller than a second resource allocation ratio corresponding to the second control group and greater than a third resource allocation ratio corresponding to the third control group.

### CROSS-REFERENCE TO RELATED APPLICATIONS

This application is a continuation of International Application No. PCT/KR2024/013981 designating the United States, filed on Sep. 13, 2024, in the Korean Ministry of Intellectual Property Receiving Office and claiming priority to Korean Patent Application No. 10-2023-0125016, filed on Sep. 19, 2023, in the Korean Intellectual Property Office, the disclosures of each of which are incorporated by reference herein in their entireties.

### BACKGROUND

### Field

The disclosure relates to an electronic device and method for resource management.

### Description of Related Art

As technology develops and advances, electronic devices may provide various functions in addition to their own functions. For example, a television (TV) may not only display broadcasting channels, but also provide functions to run applications, access websites, or communicate with other electronic devices.

An electronic device such as a TV may provide a multi-process environment in which a plurality of processes may be executed. In the electronic device providing the multi-process environment, scheduling for efficiently allocating and managing a resource may be performed. In general, the scheduling may be performed such that a second application executed in a foreground is allocated more resources than a first application or service executed in a background.

The second application requested to be executed in the foreground of the electronic device may be allocated a necessary amount of resource with the highest priority. Accordingly, the second application may be smoothly executed based on the allocated resource.

On the other hand, the first service associated with the first application and requested to be executed in the background may be allocated fewer resources than the second application. In case that the resource allocated to the first service is less than a resource required for execution of the first service, execution of the first service may be delayed, and as a result, execution of the first application may also be delayed. In case that an initialization or preparation operation for execution of the first application needs to be performed through execution of the first service after the electronic device is cold booted, execution of the first application may be further delayed.

Considering the problem described above, in case that more resources are allocated to the first service, a resource allocated to the second application on the foreground may be decreased, which may affect execution of the second application. Accordingly, a more efficient resource allocation method is required in the electronic device.

### SUMMARY

Embodiments of the disclosure may provide an electronic device and method for resource management.

Embodiments of the disclosure may provide an electronic device and a method capable of reducing a delay of a service requested to be executed in a background without affecting an application executed in a foreground.

Embodiments of the disclosure may provide an electronic device and a method allowing a service requested to be executed in a background after cold booting of the electronic device to be prepared, so that an application associated with the service may be executed more quickly.

An electronic device according to an example embodiment of the disclosure may include: memory; and at least one processor, comprising processing circuitry, electrically connected to the memory and individually and/or collectively configured to execute at least one instruction of at least one program stored in the memory, to cause the electronic device to: determine whether a first service associated with a first application and requested to be executed in a background satisfies a specified condition, allocate the first service to a first control group among a plurality of control groups based on the first service satisfying the specified condition, and allocate a resource to the first service based on a first resource allocation ratio corresponding to the first control group, the plurality of control groups may include the first control group, a second control group including a second application executed in a foreground, and a third control group including a third service executed in the background, and the first resource allocation ratio may be smaller than a second resource allocation ratio corresponding to the second control group and greater than a third resource allocation ratio corresponding to the third control group.

According to an example embodiment, the specified condition may include a condition requiring communication with at least one external device for execution of the first application.

According to an example embodiment, the electronic device may further include a display, the first application may include at least one application configured to mirror a screen displayed on the at least one external device to the display, and the resource may include a central processing unit (CPU) resource.

According to an example embodiment, the electronic device may further include a first communication interface comprising communication circuitry configured to perform communication with the at least one external device, and at least one processor, individually and/or collectively, may be configured to cause the electronic device to: receive a connection request for using the first service from the at least one external device through the first communication interface, in response to receiving the connection request, change a control group including the first service from the third control group to the first control group, allocate a resource to the first service based on the first resource allocation ratio corresponding to the first control group, and perform connection to the at least one external device based on the allocated resource.

According to an example embodiment, at least one processor, individually and/or collectively, may be configured to cause the electronic device to: based on a process of the first service being created, identify a process identifier (PID) of the process, invoke a resource allocation boosting application programming interface (API) using the identified process identifier, and in response to the invocation, determine whether the first service satisfies the predetermined condition.

According to an example embodiment, the memory may store a list of at least one service satisfying the specified condition, and at least one processor, individually and/or collectively, may be configured to cause the electronic device to, based on the list, determine whether the first service satisfies the predetermined condition.

According to an example embodiment, at least one processor, individually and/or collectively, may be configured to cause the electronic device to: identify whether description information of the first service includes indication information indicating that the first service satisfies the specified condition, and based on whether the indication information is included in the description information, determine whether the first service satisfies the specified condition.

According to an example embodiment, at least one processor, individually and/or collectively, may be configured to cause the electronic device to: perform initialization associated with the first service using the resource allocated to the first service, and based on completion of the initialization, change a control group including the first service from the first control group to the third control group.

According to an example embodiment, the initialization may include, in response to a request associated with the first application being received from at least one external device, entering a ready mode capable of processing the received request.

According to an example embodiment, the electronic device may further include a second communication interface comprising communication circuitry configured to perform communication with a remote controller configured to control the electronic device, and at least one processor, individually and/or collectively, may be configured to cause the electronic device to: receive, through the second communication interface, a control signal from the remote controller instructing execution of a third application included in the electronic device, and create, in response to reception of the control signal, a process for execution of the third application and change a control group including the first service from the first control group to the third control group.

A method according to an example embodiment of the disclosure may include, in a method for allocating a resource by an electronic device: determining whether a first service associated with a first application and requested to be executed in a background satisfies a specified condition; allocating, based on the first service satisfying the specified condition, the first service to a first control group among a plurality of control groups; and allocating a resource to the first service based on a first resource allocation ratio corresponding to the first control group, the plurality of control groups may include the first control group, a second control group including a second application executed in a foreground, and a third control group including a third service executed in the background, and the first resource allocation ratio may be smaller than a second resource allocation ratio corresponding to the second control group and greater than a third resource allocation ratio corresponding to the third control group.

According to an example embodiment, the specified condition may include a condition requiring communication with at least one external device for execution of the first application.

According to an example embodiment, the first application may include at least one application configured to mirror a screen displayed on the at least one external device to a display of the electronic device, and the resource may include a central processing unit (CPU) resource.

According to an example embodiment, the method may further include: receiving a connection request for using the first service from the at least one external device; in response to receiving the connection request, changing a control group including the first service from the third control group to the first control group; allocating a resource to the first service based on the first resource allocation ratio corresponding to the first control group; and performing connection to the at least one external device based on the allocated resource.

According to an example embodiment, determining whether the first service satisfies the specified condition may include: based on a process of the first service being created, identifying a process identifier (PID) of the process; invoking a resource allocation boosting application programming interface (API) using the identified process identifier; and in response to the invocation, determining whether the first service satisfies the predetermined condition.

According to an example embodiment, determining whether the first service satisfies the specified condition may include: based on a list of at least one service satisfying the specified condition, determining whether the first service satisfies the specified condition.

According to an example embodiment, determining whether the first service satisfies the specified condition may include: identifying whether description information of the first service includes indication information indicating that the first service satisfies the specified condition; and based on whether the indication information is included in the description information, determining whether the first service satisfies the specified condition.

According to an example embodiment, the method may further include: performing initialization associated with the first service using the resource allocated to the first service and based on completion of the initialization, changing a control group including the first service from the first control group to the third control group.

According to an example embodiment, the initialization may include, based on a request associated with the first application being received from at least one external device, entering a ready mode capable of processing the received request.,

According to an example embodiment, the method may further include: receiving, from a remote controller configured to control the electronic device, a control signal instructing execution of a third application included in the electronic device; and in response to reception of the control signal, creating a process for execution of the third application and changing a control group including the first service from the first control group to the third control group.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a graph illustrating example task processing delay caused by CPU contention according to various example embodiments.

FIG. 2 is a graph illustrating context switch latency that may occur according to a scheduling scheme according to various example embodiments.

FIG. 3 is a diagram illustrating an example of an electronic device according to various example embodiments.

FIG. 4 is a signal flow diagram illustrating an example operation of executing a screen mirroring app of an electronic device by at least one external device according to various example embodiments.

FIG. 5 is a system architecture diagram illustrating example CPU resource management of an electronic device according to various example embodiments.

FIG. 6 is a diagram illustrating an example control group allocation operation associated with CPU resource management according to various example embodiments.

FIG. 7 is a flowchart illustrating an example resource allocation operation of an electronic device according to various example embodiments.

FIG. 8 is a flowchart illustrating an example operation in which an electronic device performs an initialization operation and changes a control group of a first service according to various example embodiments.

FIG. 9 is a flowchart illustrating an example operation in which an electronic device processes a connection request of at least one external device according to various example embodiments.

FIG. 10 is a flowchart illustrating an example operation of an electronic device in case that application execution is instructed by a remote controller according to various example embodiments.

FIG. 11 is a block diagram illustrating an example configuration of an electronic device according to various example embodiments.

In connection to the description of the drawings, identical or similar reference numerals may be used for identical or similar components.

### DETAILED DESCRIPTION

Hereinafter, various example embodiments of the disclosure are described in greater detail with reference to the drawings. However, the disclosure may be implemented in various forms and is not limited to the example embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

In the electronic device, in case that a system is busy such as during cold booting, a user interface (UI) response may be delayed, causing a stuttering phenomenon. One of various causes of the phenomenon is central processing unit (CPU) contention. The CPU contention may indicate CPU resource competition in which a plurality of processes (or threads) compete to occupy a CPU resource. The CPU contention may occur in case that the plurality of processes are not allocated a required amount of CPU resource. A process that has failed in the CPU contention and has not been allocated a required amount of resource may have to wait until it is allocated the CPU resource. In this case, processing of a task (or work) associated with the process may be delayed.

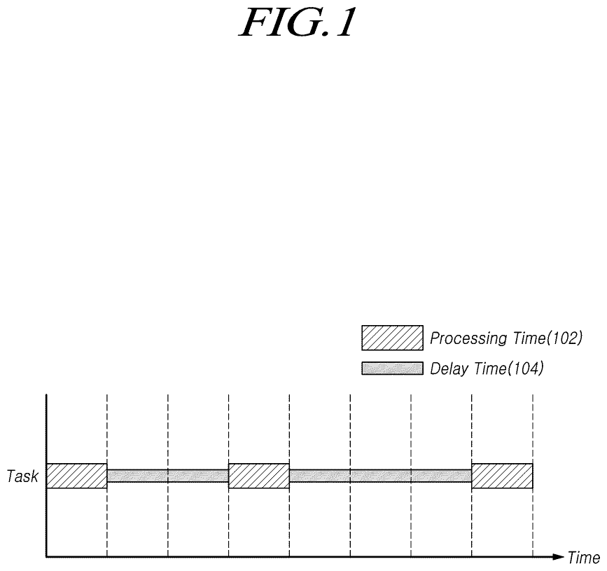

FIG. 1 is a graph illustrating example task processing delay caused by CPU contention according to various example embodiments.

Referring to FIG. 1, a process that has not been allocated a resource in the CPU contention may have task processing delayed until the resource is allocated. For example, in case that a task associated with a process has a processing time (or work time) 102 of 0.1 second and the process waits for 1 second until a resource is allocated in the CPU contention, the task processing may be completed after 1.1 seconds have elapsed. In other words, the time during which the task is processed may be delayed by a delay time 104 of 1 seconds. Delay in processing the task may cause inconvenience to the user. For example, in case that the task is related to the key input processing of the TV remote control, the user may feel uncomfortable because the response to the key input of the TV remote control is delayed.

Various CPU resource management methods may be used so that CPU resource allocation is performed more efficiently. For example, a real-time scheduling scheme (hereinafter referred to as a “Real-Time scheduling scheme”) and a completely fair scheduler (CFS) scheduling scheme may be used in the Linux kernel.

The Real-Time scheduling scheme may refer, for example, to a scheduling scheme for preempting a CPU resource based on priority and may be used by, e.g., a Real-Time scheduler or an O(1) scheduler. The Real-Time scheduling scheme may be used for real-time tasks with the highest priority. In the Real-Time scheduling scheme, a first in first out (FIFO) (or first come first served) policy for allocating a CPU resource first to a first prepared process, or a round robin policy for allowing processes to use the CPU resource in order may be used.

The CFS scheduling scheme may refer, for example, to a scheduling scheme for fairly allocating a CPU resource and may be used by, e.g., a CFS scheduler. The CFS scheduling scheme may be used for tasks with a priority lower than that of real-time tasks. The CFS scheduling scheme may be used to allocate a CPU resource to a process included in each control group based on a CPU resource usage amount determined for each control group (or Cgroup). In the CFS scheduling scheme, a round robin policy may be used.

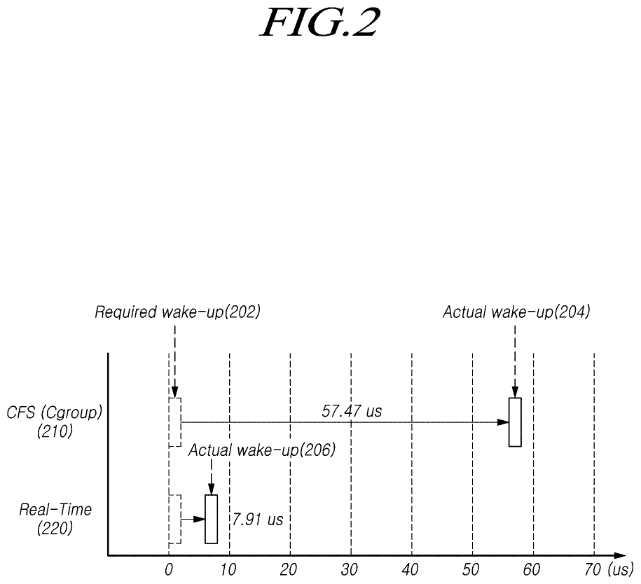

FIG. 2 is a graph illustrating example context switch latency that may occur according to a scheduling scheme according to various example embodiments.

Referring to FIG. 2, a context switch latency that may occur in case that the CFS scheduling scheme 210 is used may be longer than a context switch latency that may occur in case that the Real-Time scheduling scheme 220 is used.

The context switch latency may refer, for example, to a time delay occurring in the process switching process. For example, the context switch latency may indicate the time it takes for a process in a standby state to wake up.

According to an example, in case that the CFS scheduling scheme 210 is used, an actual process wake-up 204 may be performed 57.47 us after the required wake-up time 202. Therefore, in case that the CFS scheduling scheme 210 is used, a context switch latency of 57.47 us may occur.

According to an example, in case that the Real-Time scheduling scheme 220 is used, the actual process wake-up 206 may be performed 7.91 us after the required wake-up time 202. Therefore, in case that the Real-Time scheduling scheme 220 is used, a context switch latency of 7.91 us may occur.

The CFS scheduling scheme 210 may avoid and/or reduce a CPU starvation state from occurring by allowing processes to use CPU resources fairly. The CPU starvation state may indicate a state in which another process occupies the CPU resource, and thus a specific process may not use the CPU resource. The CFS scheduling scheme 210 may be used for tasks that need to be performed for a long time because it has a relatively long context switch latency and does not always guarantee the use of CPU resources.

The Real-Time scheduling scheme 220 may have a relatively short context switch latency and guarantee use of CPU resources until the process itself transitions to sleep state. Therefore, the Real-Time scheduling scheme 220 may be easily used for a real-time task. The Real-Time scheduling scheme 220 may be used for a task that needs to be performed for a short time because it may cause a CPU starvation state in which other processes may not use the CPU.

The CFS scheduling scheme 210 and the Real-Time scheduling scheme 220 may be used together in one operating system (OS). For example, resources may be allocated to processes related to the reproduction of media (e.g., video or audio) based on the Real-Time scheduling scheme 220, thereby guaranteeing CPU usage and avoiding and/or reducing disconnection of media reproduction. Resources may be allocated to processes associated with applications executed in the foreground based on the CFS scheduling scheme 210. For example, the application may be executed smoothly by allocating the process to a control group that may use more CPU resources than other processes.

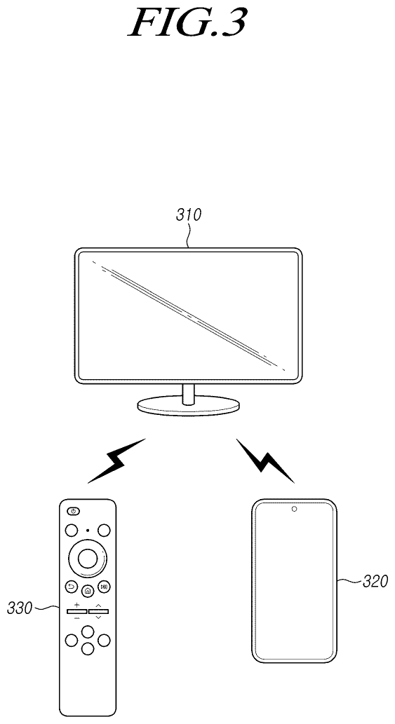

FIG. 3 is a diagram illustrating an example of an electronic device according to various example embodiments.

Referring to FIG. 3, an electronic device 310 may be a display device such as a TV. However, this is merely an example, and the electronic device 310 may also be a tablet PC, a mobile phone, or various types of devices capable of providing a service based on various applications.

The electronic device 310 may perform wired and/or wireless communication with at least one external device 320. According to an example, the electronic device 310 may perform wired communication with the at least one external device 320 using a cable (e.g., a high-definition multimedia interface (HDMI) cable). According to an example, the electronic device 310 may perform wireless communication with the at least one external device 320 based on various wireless communication technologies (e.g., wireless fidelity (Wi-Fi), Bluetooth, long term evolution (LTE), LTE advance (LTE-A), or new radio (NR) communication technology).

The at least one external device 320 may be, e.g., a mobile terminal such as a tablet PC or a mobile phone. The at least one external device 320 is not limited to one as illustrated in FIG. 3 and may be two or more.

The electronic device 310 may perform infrared (IR) communication or radio frequency (RF) communication with a remote controller 330. The remote controller 330 may be referred to as a remote controller or remote control, and may include various input units (e.g., key buttons, switches, wheels, or touch screens) for controlling the electronic device 310. The remote controller 330 may transmit a control signal for controlling the electronic device 310 to the electronic device 310 based on a user input through the various input units. According to an example, the control signal may include at least one of a control signal for turning on or off a power of the electronic device 310, a control signal for changing a broadcast channel, a control signal for adjusting a volume, a control signal for executing or terminating an application, or a control signal for changing a setting related to the electronic device 310.

The electronic device 310 may include one or more applications. According to an example, the one or more applications may include an application executable by the at least one external device 320 and/or an application executable by the remote controller 330. For example, a screen mirroring application (hereinafter referred to as ‘screen mirroring app’) may be executed by the at least one external device 320. The screen mirroring app may include at least one application for mirroring a screen displayed on the at least one external device 320 to a screen of the electronic device 310.

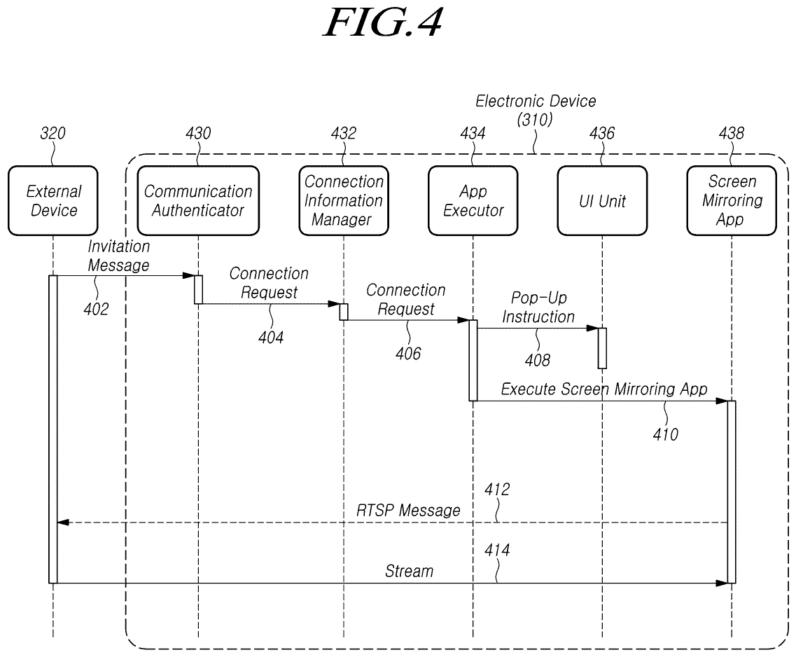

Hereinafter, an operation in which the at least one external device 320 executes the screen mirroring app of the electronic device 310 is described in greater detail with reference to FIG. 4. Referring to FIG. 4, an example in which the at least one external device 320 and the electronic device 310 perform communication based on Wi-Fi direct or Wi-Fi peer-to-peer (P2P) technology is described. However, communication between the at least one external device 320 and the electronic device 310 is not limited thereto and may be performed based on other wireless communication technologies such as Bluetooth.

FIG. 4 is a signal flow diagram illustrating an example operation of executing a screen mirroring app of an electronic device by at least one external device according to various example embodiments.

Referring to FIG. 4, in operation 402, the at least one external device 320 may transmit an invitation message for establishing a connection to the electronic device 310 to the electronic device 310 in order to execute the screen mirroring app 438 of the electronic device 310. According to an example, the invitation message may be a message for performing a P2P connection to the electronic device 310. For example, the invitation message may be a message for inviting the electronic device 310 to join an existing P2P group or for invoking a persistent P2P group previously established between the at least one external device 320 and the electronic device 310.

The invitation message transmitted by the at least one external device 320 to the electronic device 310 may be received by a communication authenticator 430 of the electronic device 310. The communication authenticator 430 may be referred to as a supplicant, but the disclosure is not limited thereto. The communication authenticator 430 may perform communication authentication between the electronic device 310 and the at least one external device 320 based on information included in the invitation message. According to an example, the invitation message may include at least one of a P2P group identifier (ID), a P2P group basic service set identifier (BSSID), channel information, configuration time information required from a response to the invitation message until the electronic device 310 is ready to join the P2P group, authentication information such as a password, information associated with the screen mirroring app 438, or information requesting execution of the screen mirroring app 438.

In case that the communication between the electronic device 310 and the at least one external device 320 is authenticated, the communication authenticator 430 may make a connection request to a connection information manager 432 in operation 404. According to an example, the connection information manager 432 may include a module (e.g., a Wi-Fi direct (WFD) manager) managing Wi-Fi direct or P2P connection information between the electronic device 310 and the at least one external device 320.

In operation 406, the connection information manager 432 may transmit a connection request to an app executor 434 in response to the connection request received from the communication authenticator 430. According to an example, the app executor 434 may include a P2P-access service management (ASM) module for application execution.

In operation 408, the app executor 434 may instruct a UI unit 436 to display UI information (e.g., pop up-type UI information) and, in operation 410, may instruct execution of the screen mirroring app 438. Operations 408 and 410 may be performed simultaneously, or operation 408 may be performed after operation 410.

According to an example, the UI unit 436 may be referred to as a P2P-access management service (AMS)-UI unit providing a UI related to P2P-ASM, but the disclosure is not limited thereto. The UI unit 436 may include a module or a UI application displaying a state (or an execution state) of the app executor 434 as UI information. The state of the app executor 434 may include an operation state of the app executor 434, such as whether the app executor 434 has received a connection request or whether the app executor 434 has made an execution instruction to an application (e.g., the screen mirroring app 438).

In case that the screen mirroring app 438 is executed based on the execution instruction of the app executor 434, the screen mirroring app 438 may be in a state capable of performing screen mirroring. In case that execution is completed, the screen mirroring app 438 may transmit a response message to the at least one external device 320 in operation 412. According to an example, the response message may include a response message to the invitation message of operation 402. The response message may be transmitted using a real-time streaming protocol (RTSP), but the disclosure is not limited thereto. According to an example, the response message may include information for requesting data (e.g., image data, file data, text data, video data, media data, or streaming data) necessary for screen mirroring of the electronic device 310.

In operation 414, the at least one external device 320 may transmit data for screen mirroring to the electronic device 310 in response to receiving the response message. According to an example, the at least one external device 320 may transmit the data for screen mirroring in a stream form.

As illustrated in FIG. 4, the electronic device 310 may need to perform an operation related to a connection or communication with the at least one external device 320 (e.g., an operation of the communication authenticator 430, the connection information manager 432, or the app executor 434) in order to execute the screen mirroring app 438. According to an example, the communication authenticator 430, the connection information manager 432, or the app executor 434 may be included in a service associated with the screen mirroring app 438 and may be referred to as a service associated with the screen mirroring app 438. By performing the service associated with the screen mirroring app 438 as in operations 402 to 410, the screen mirroring app 438 may be executed and may enter a ready mode capable of processing a request from the at least one external device 320.

According to an example, the service associated with the screen mirroring app 438 may be registered as a service that needs to be executed in a background after cold booting of the electronic device 310. The cold booting may indicate that the electronic device 310 is booted by completely cutting off power and then applying power again.

In a general OS, a plurality of control groups may be used. The plurality of control groups may include a foreground control group and a background control group. The foreground control group may include an application executed in a foreground, and the background control group may include an application or service executed in a background.

A larger amount of CPU resource may be allocated to the foreground control group than to the background control group. Accordingly, the application on the foreground may be smoothly executed, but the application or service on the background may lack CPU resources and thus may be restricted in smooth execution. For example, referring to FIG. 4, execution of at least one service associated with the screen mirroring app 438 may be delayed due to a lack of CPU resources, and thus execution of the screen mirroring app 438 may also be delayed. In other words, execution of the screen mirroring app 438 may be delayed until a CPU resource for executing the at least one service associated with the screen mirroring app 438 is sufficiently secured.

Even after the electronic device 310 completes cold booting, a home application screen is displayed, and a state in which user manipulation is possible is entered, the electronic device 310 may not process a request from the at least one external device 320 in case that a CPU resource for service initialization is insufficient. Accordingly, execution of the screen mirroring app 438 may be delayed until a CPU resource is additionally secured.

Considering the matter described above, the following method for providing a service requested to be executed in a background more quickly may be used.

According to an example, the electronic device 310 may identify whether a first service associated with a first application and requested to be executed in a background satisfies a predetermined condition. According to an example, the predetermined condition may include a condition requiring communication (or connection) with the at least one external device 320 for execution of the first application, or a condition in which the first application is executed based on a request from the at least one external device 320. According to an example, the first application may be the screen mirroring app 438 of FIG. 4.

According to an example, the electronic device 310 may allocate the identified first service to a first control group among a plurality of control groups. According to an example, the first control group may also be referred to as a service control group. The plurality of control groups may further include a second control group, a third control group, and a fourth control group in addition to the first control group.

According to an example, the second control group may include a second application executed in a foreground. The second application may be an application displayed on a screen of the electronic device 310 and being executed. The second application may be, e.g., a UI application providing a graphical user interface (GUI). According to an example, the second control group may be referred to as a foreground control group or a running control group.

According to an example, the third control group may be a control group including a third service executed in a background. The third service may not be displayed on a screen of the electronic device 310. According to an example, the third control group may be referred to as a normal control group and may be set as a default control group.

According to an example, the fourth control group may be a control group including a fourth application on a background. The fourth application may not be displayed on a screen of the electronic device 310 and may be an application or UI application executed in a background. According to an example, the fourth control group may be referred to as a background control group.

According to an example, a priority associated with CPU resource allocation may be high in an order of the second control group, the first control group, the third control group, and the fourth control group. According to an example, a higher priority may result in a higher CPU resource allocation ratio. For example, a second resource allocation ratio corresponding to the second control group may be the largest, and a fourth resource allocation ratio corresponding to the fourth control group may be the smallest. A first resource allocation ratio corresponding to the first control group may be smaller than the second resource allocation ratio and greater than the third and fourth resource allocation ratios. A third resource allocation ratio corresponding to the third control group may be smaller than the first and second resource allocation ratios and greater than the fourth resource allocation ratio. This is summarized as illustrated in [Table 1] below.

TABLE 1

| | First | Second | Third | Fourth |
|---|---|---|---|---|
| | Control Group | Control Group | Control Group | Control Group |
| | (Service | (Foreground | (Normal | (Background |
| | Control Group) | Control Group) | Control Group) | Control Group) |
| priority | 2 | 1 | 3 | 4 |
| Resource | 20% | 70% | 7% | 3% |
| Allocation Ratio | | | | |

Referring to [Table 1], the first service included in the first control group is allocated a resource at a lower ratio than the second application being executed in the foreground, but may be allocated a resource at a higher ratio than the third service and the fourth application on the background. Since the first control group is not included in the plurality of control groups generally used, the first service had to be included in the third control group. Since the third control group has a lower priority and a lower resource allocation ratio than the first control group, in case that the first control group is used, a CPU resource amount allocated to the first service increases, and thus the execution performance of the first service may be enhanced. As a result, as the execution performance of the first service is enhanced, the execution performance of the first application based on the first service may be enhanced, and a user experience expecting fast UI responsiveness may be enhanced.

In case that the resource allocation ratio for the second application on the foreground is decreased, a CPU resource amount allocated to the second application is decreased, and thus a performance delay may occur. Accordingly, the resource allocation ratio for the second application on the foreground may be set to the same or a similar ratio as before. According to an example, the first to fourth resource allocation ratios corresponding to each of the first to fourth control groups may be set based on different weight values.

For example, the first to fourth resource allocation ratios may be set to be proportional to weight values set for each of the first to fourth control groups. The second control group may have the largest weight value, and the fourth control group may have the smallest weight value. The first control group may have a weight value smaller than the weight value of the second control group and greater than the weight values of the third and fourth control groups. The third control group may have a weight value smaller than the weight values of the first and second control groups and greater than the weight value of the fourth control group. According to an example, the weight value of the second control group may be set to a value for avoding and/or reducing a resource allocation amount for the second application on the foreground from being decreased compared to before.

As described above, the first control group may be a separate control group distinguished from the second to fourth control groups. As another example, the first control group may be included in one of the second control group and the third control group.

According to an example, in case that the first control group is included in the second control group, the first service included in the first control group may have a lower priority than the second application included in the second control group. Further, the first service may have a higher priority than the third service included in the third control group and the fourth application included in the fourth control group.

According to an example, in case that the first control group is included in the third control group, the first service included in the first control group may have a higher priority than the third service included in the third control group and the fourth application included in the fourth control group. Further, the first service may have a lower priority than the second application included in the second control group.

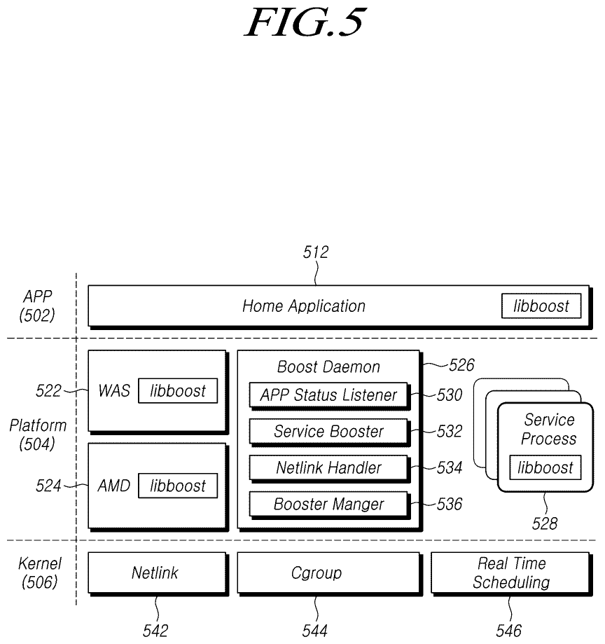

FIG. 5 is a system architecture diagram for example CPU resource management of an electronic device according to various example embodiments.

Referring to FIG. 5, a system for CPU scheduling of the electronic device 310 may include an application 502, a platform 504, and a kernel 506.

The application 502 may also be referred to as APP or app and may be associated with a service. The application 502 may include a software program executed by selection of a user. According to an example, the application 502 may be executed by selection of a user using the at least one external device 320 or the remote controller 330. According to an example, the application 502 may be executed based on an OS and may be displayed or not displayed on a screen of the electronic device 310. The application 502 may provide various services such as media playback. According to an example, the application 502 may include a home application 512 displayed on the screen of the electronic device 310 after cold booting. According to an example, the home application 512 may be an application providing a UI for at least one of application selection, website search, broadcast channel selection, or external device connection.

The platform 504 may be associated with an OS and may provide an environment for executing the application 502. The platform 504 may access hardware through the kernel 506 and may perform control group allocation, control group change or movement, CPU resource allocation, or process management operations associated with services. According to an example, the platform 504 may include a web application service (WAS) 522, an application management daemon (AMD) 524, a boost daemon (or a boost module) 526, and a service process (or process) 528.

The WAS 522 may perform operations to provide web-based application services. The AMD 524 may manage the execution of the application 502 and the life cycle of the application 502.

The boost daemon 526 may perform CPU scheduling and/or CPU resource management. According to an example, the boost daemon 526 may include an app status listener 530, a service booster 532, a netlink handler 534, and a booster manager 536.

The app status listener 530 may receive events associated with the lifecycle of the application 502. The service booster 532 may manage CPU resource allocation of the service process 528. The netlink handler 534 may receive events associated with the lifecycle of the process. The booster manager 536 may set a CPU policy (or CPU scheduling scheme), control group allocation, resource allocation ratio determination, or CPU resource allocation priority.

The service process 528 may be a process operating in the background without a UI, and may provide functions necessary for the operation of the UI application. For example, a service process 528 may be related to a service associated with the screen mirroring app 438 of FIG. 4. There may be one or more service processes 528.

The kernel 506 may manage hardware and provide a necessary service to the platform 504. The kernel 506 may include a netlink 542, a Cgroup 544, and a real-time scheduling unit 546.

The netlink 542 may provide an event associated with a lifecycle of the service process (or task) 528 (e.g., a process fork event, a process execute event, or a process exit event). The Cgroup 544 may provide a CPU resource distribution function. Referring to [Table 1] described above, the Cgroup 544 may provide a CPU resource distribution function for each of the first control group to the fourth control group. The real-time scheduling unit 546 may perform real-time scheduling that preempts CPU resources.

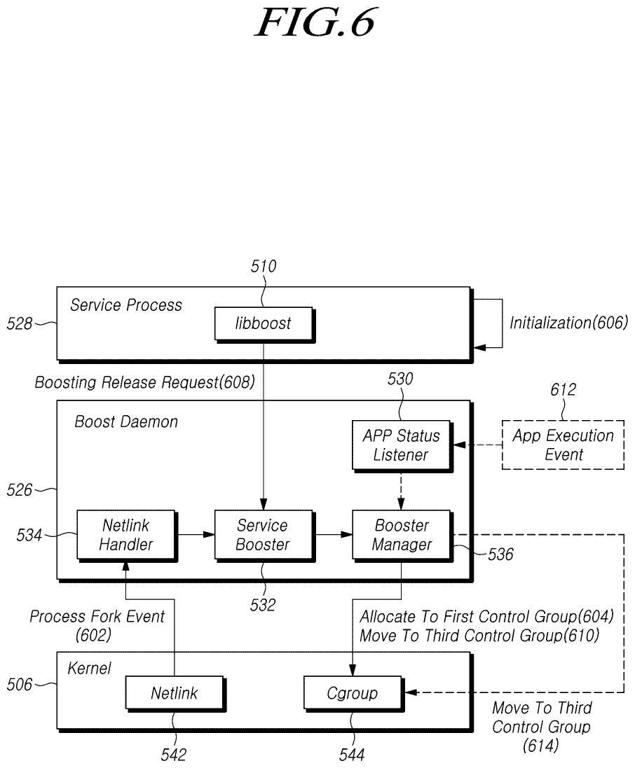

A control group allocation operation associated with CPU scheduling of the service process 528 may be performed through a boost daemon 526 of FIG. 5 and the kernel 506. This is described in greater detail below with reference to FIG. 6.

FIG. 6 is a diagram illustrating an example control group allocation operation associated with CPU resource management according to various example embodiments.

Referring to FIG. 6, in operation 602, the netlink 542 of the kernel 506 may provide a process fork event to the boost daemon 526. The boost daemon 526 may receive the process fork event through a netlink handler 534. According to an example, the process fork event may be an event associated with creation of the service process 528. For example, the process fork event may be an event indicating a state in which a service is launched, a process identifier (PID) is allocated to the service process 528, and a main thread (or main task) is created. According to an example, the process execute event that may be provided from the netlink 542 may be an event indicating execution of the service process 528 that may occur after the process fork event. According to an example, the process exit event may be an event indicating termination of the service process 528 that may occur after the process execute event.

The netlink handler 534 may receive the process fork event and provide information about the received process fork event to the service booster 532. The service booster 532 may receive the information about the process fork event from the netlink handler 534 and transfer the received information to a booster manager 536 for CPU resource allocation for the service process 528.

In operation 604, the booster manager 536 may allocate the service process 528 to a first control group among a plurality of control groups and provide information indicating that the service process 528 is allocated to the first control group to the Cgroup 544. According to an example, an operation of allocating the service process 528 to one of the plurality of control groups or changing the control group of the service process 528 may be performed based on a PID of the service process 528.

The Cgroup 544 may allocate a CPU resource to the service process 528 based on a first resource allocation ratio corresponding to the first control group, based on the information received from the booster manager 536.

In operation 606, the service process 528 may perform initialization based on the allocated CPU resource. According to an example, the initialization may include a preparation operation (or a preliminary operation) that needs to be performed to execute an application based on the service process 528. For example, in case that the first service is associated with the screen mirroring app 438 of FIG. 4, the initialization may include an operation of entering a ready mode capable of receiving and processing a message or request from the at least one external device 320.

In operation 608, in case that the initialization is completed, the service process 528 may invoke a boost library (libboost) (or a resource allocation boosting release API) to request boosting release from the boost daemon 526. According to an example, requesting boosting release may include requesting release or change of a control group set for the service process 528. According to an example, requesting boosting release may include requesting to change or move the set control group (e.g., the first control group) to a control group with a lower priority (e.g., the third control group).

The boosting release request of operation 608 may be received by the service booster 532 of the boost daemon 526 and transferred to the booster manager 536.

In operation 610, the booster manager 536 may move the service process 528 from the first control group to the third control group in response to the boost release request. The booster manager 536 may provide information indicating that the service process 528 is moved to the third control group to the Cgroup 544.

The Cgroup 544 may allocate (or distribute) a CPU resource to the service process 528 based on a third resource allocation ratio corresponding to the third control group, based on the information received from the booster manager 536.

In operation 612, an app status listener 530 may receive an app execution event. According to an example, the app execution event may be an event requesting execution of an application. The application associated with the app execution event may be, e.g., an application (e.g., over the top (OTT)) providing another service that does not require communication with the at least one external device 320. According to an example, the app execution event may be received based on a control signal transmitted from the remote controller 330. The control signal transmitted from the remote controller 330 may be, e.g., a control signal based on a key input of a user on the remote controller 330.

The app status listener 530 may provide information indicating that the app execution event is received to the booster manager 536. The booster manager 536 may determine that the application associated with the app execution event is executed based on the received information. The booster manager 536 may move the service process 528 from the first control group to the third control group so that a CPU resource may be sufficiently used in a process associated with the corresponding application. The booster manager 536 may provide information indicating that the service process 528 is moved to the third control group to the Cgroup 544.

In operation 614, the Cgroup 544 may allocate a CPU resource corresponding to the third resource allocation ratio of the third control group to the service process 528 based on the information received from the booster manager 536.

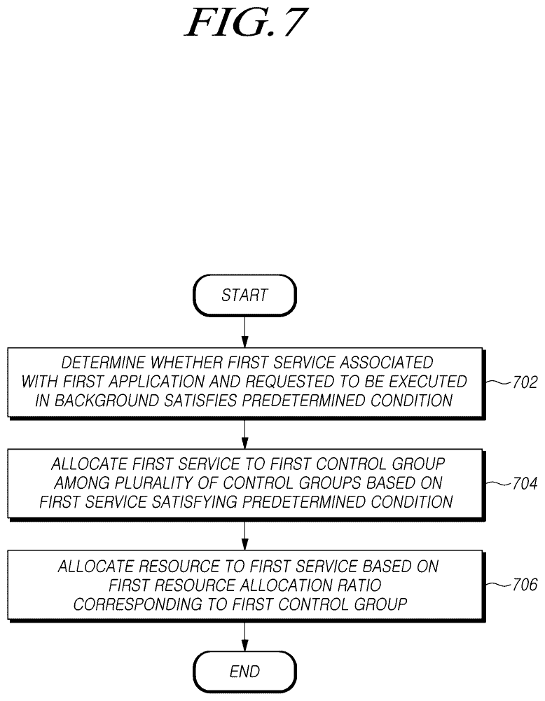

FIG. 7 is a flowchart illustrating an example resource allocation operation of an electronic device according to various example embodiments.

Referring to FIG. 7, in operation 702, the electronic device 310 may determine whether a first service associated with a first application and requested to be executed in a background satisfies a predetermined condition. According to an example, the predetermined condition may include a condition requiring communication (or connection) with the at least one external device 320 for execution of the first application. According to an example, the first service may be a service in which the service is launched and a service process is created (or a service in which a process fork event occurs).

According to an example, determining whether the first service satisfies the predetermined condition may include an operation in which the electronic device 310 identifies a PID of a process based on the process of the first service being created (or based on a process fork event for the first service occurring), an operation of invoking a resource allocation boosting API based on the identified PID, and an operation of determining whether the first service satisfies the predetermined condition in response to the invocation of the resource allocation boosting API. Such an operation may be directly performed by the first service (e.g., the communication authenticator 430, the connection information manager 432, or the app executor 434 of FIG. 4).

According to an example, determining whether the first service satisfies the predetermined condition may include an operation in which the electronic device 310 determines whether the first service satisfies the predetermined condition based on a list of at least one service satisfying the predetermined condition. For example, the electronic device 310 may determine that the first service satisfies the predetermined condition in case that the list includes information about the first service, and may determine that the first service does not satisfy the predetermined condition in case that the list does not include the information about the first service.

According to an example, in case that the application associated with the first service is installed on the electronic device 310 and in case that it is identified that the first service satisfies the predetermined condition, the electronic device 310 may add the information about the first service to the list. The list may be stored in a file form at a first path in the electronic device 310. The stored list may be used in case that the electronic device 310 is cold booted and at least one service is launched by a service launcher.

According to an example, determining whether the first service satisfies the predetermined condition may include an operation in which the electronic device 310 identifies whether description information of the first service includes indication information indicating that the first service satisfies the predetermined condition, and an operation of determining whether the first service satisfies the predetermined condition based on whether the indication information is included in the description information.

According to an example, in case that the electronic device 310 is cold booted and the first service is launched by a service launcher, the service launcher may identify the description information of the first service. According to an example, the description information may be stored at a second path in the electronic device 310. In case that the description information includes the indication information, the service launcher may invoke a resource allocation boosting API for raising the priority or resource allocation ratio of the first service and transfer PID information associated with the process of the first service to a boost daemon (e.g., the boost daemon 526 of FIG. 5).

In operation 704, the electronic device 310 may allocate the first service to a first control group among a plurality of control groups based on the first service satisfying the predetermined condition. According to an example, the plurality of control groups may include the first control group, a second control group including a second application executed in a foreground, and a third control group including a third service executed in a background.

In operation 706, the electronic device 310 may allocate a resource to the first service based on a first resource allocation ratio corresponding to the first control group. According to an example, the first resource allocation ratio may be smaller than a second resource allocation ratio corresponding to the second control group and greater than a third resource allocation ratio corresponding to the third control group. According to an example, the first application may include at least one application executed to mirror a screen displayed on the at least one external device 320 to a display of the electronic device 310, and the resource may include a CPU resource.

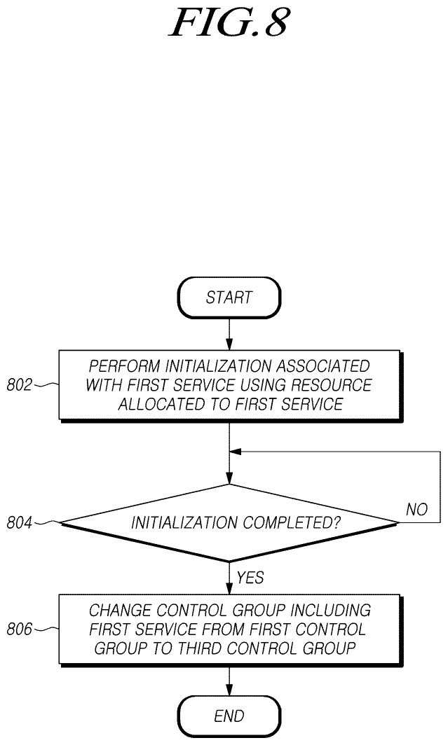

FIG. 8 is a flowchart illustrating an example operation in which an electronic device performs an initialization operation and changes a control group of a first service according to various example embodiments.

Referring to FIG. 8, in operation 802, the electronic device 310 may perform initialization associated with the first service using the resource allocated to the first service. According to an example, the resource allocated to the first service may be the resource allocated in operation 706 of FIG. 7. According to an example, the initialization may include an operation of entering a service ready mode capable of processing a received request in response to a request (or a message or information) associated with the first application being received from the at least one external device 320. For example, in case that the first service is associated with the screen mirroring app 438 of FIG. 4, the initialization may include an operation in which the communication authenticator 430, the connection information manager 432, or the app executor 434 of FIG. 4 enters a ready mode so as to be able to process a request from the at least one external device 320.

In operation 804, the electronic device 310 may determine whether the initialization is completed. The electronic device 310 may continue to perform the initialization operation in case that the initialization is not completed, and may perform operation 806 in case that the initialization is completed.

In operation 806, the electronic device 310 may change a control group including the first service from the first control group to the third control group based on the initialization being completed. According to an example, completion of the initialization may indicate that the electronic device 310 may process a request (e.g., a connection request) from the at least one external device 320 through the first application based on the first service.

The electronic device 310 may determine that preparation for processing a request from the at least one external device 320 through the first application is completed based on the initialization being completed, and may move the first service to the third control group having a lower priority or resource allocation ratio than the first control group. According to an example, in order to change the control group including the first service, a resource allocation boosting release API of the boost daemon 526 may be invoked. The resource allocation boosting release API may be used to request that the priority or resource allocation ratio be set lower.

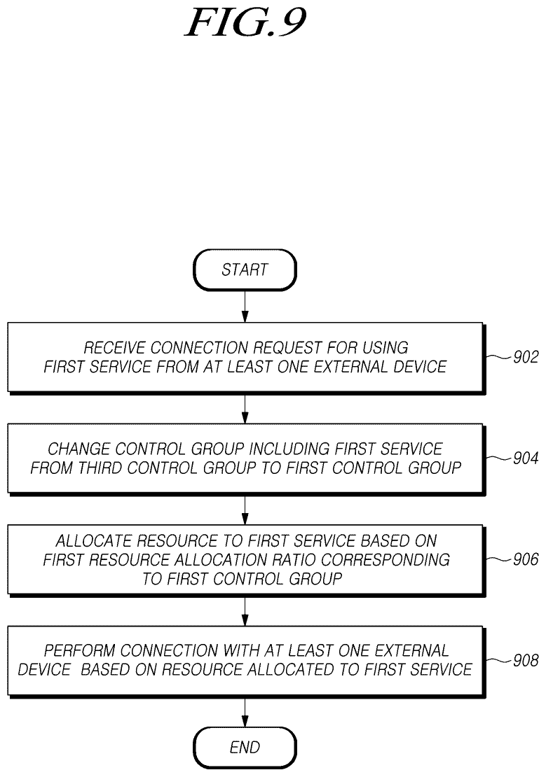

FIG. 9 is a flowchart illustrating an example operation in which an electronic device processes a connection request of at least one external device according to various example embodiments.

Referring to FIG. 9, in operation 902, the electronic device 310 may receive a connection request for using the first service from the at least one external device 320.

In operation 904, the electronic device 310 may change a control group including the first service from the third control group to the first control group in response to receiving the connection request. According to an example, the first control group may be a control group having a higher priority or resource allocation ratio than the third control group and not affecting the second application executed in the foreground. According to an example, in order to change the control group including the first service, a resource allocation boosting request API of the boost daemon 526 may be invoked. The resource allocation boosting request API may be used to request that the resource allocation priority or resource allocation ratio be set higher.

In operation 906, the electronic device 310 may allocate a resource to the first service based on a first resource allocation ratio corresponding to the first control group.

In operation 908, the electronic device 310 may perform connection to the at least one external device 320 based on the resource allocated to the first service.

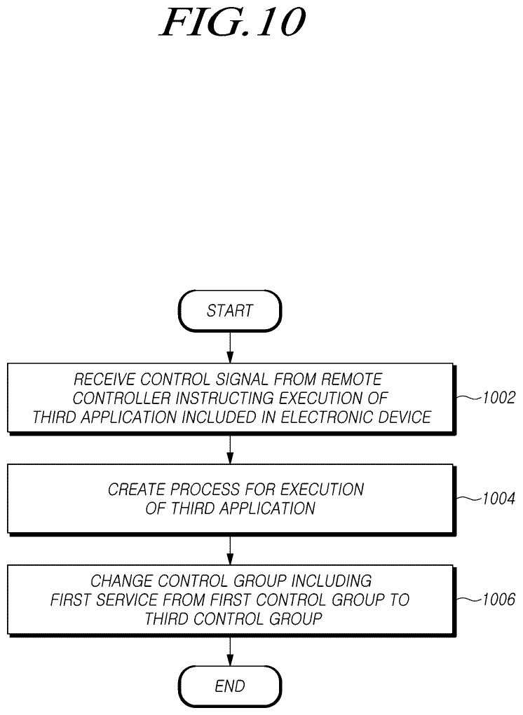

FIG. 10 is a flowchart illustrating an example operation of an electronic device in case that application execution is instructed by a remote controller according to various example embodiments.

Referring to FIG. 10, in operation 1002, the electronic device 310 may receive a control signal from the remote controller 330 instructing execution of a third application included in the electronic device 310. For example, the control signal may be a signal corresponding to a key input of a user generated for execution of the third application on the remote controller 330.

In operation 1004, the electronic device 310 may create a process for execution of the third application. According to an example, in case that a process is created, a process fork event may occur, and the occurring process fork event may be identified by the boost daemon 526 of FIG. 5. In case that it is identified that a process associated with the third application instructed by the control signal is created based on the process fork event, the boost daemon 526 may determine that the third application instructed by the remote controller 330 is executed.

In operation 1006, in case that execution of the third application is determined, the electronic device 310 may change a control group including the first service from the first control group to the third control group. For example, in case that a key is input by a user through the remote controller 330, a CPU resource allocation ratio may be lowered for at least one service (e.g., communication authentication, connection information management, etc.) associated with the screen mirroring app.

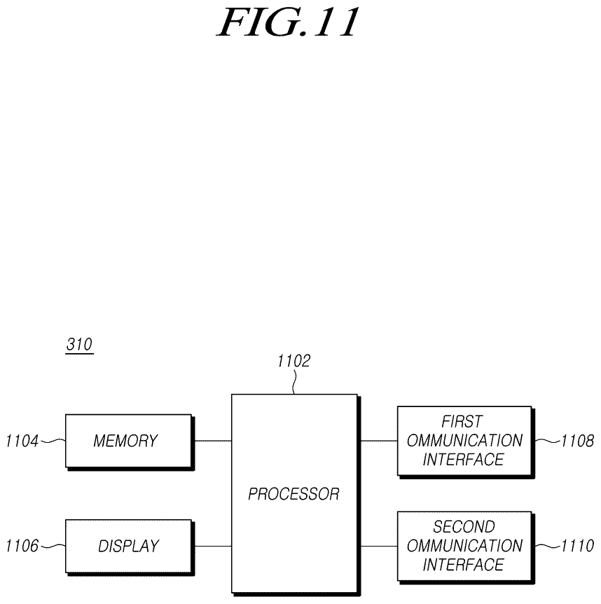

FIG. 11 is a block diagram illustrating an example configuration of an electronic device according to various example embodiments.

Referring to FIG. 11, the electronic device 310 may include a processor (e.g., including processing circuitry) 1102, a memory 1104, a display 1106, a first communication interface (e.g., including communication circuitry) 1108, and a second communication interface (e.g., including communication circuitry) 1110. According to an example, the electronic device 310 may include additional components (e.g., an audio output unit) in addition to the illustrated components or may omit at least one of the illustrated components.

According to an example, the memory 1104 may store various pieces of information or data related to an operation of the electronic device 310, and may store at least one program.

According to an example, the display 1106 may perform various display operations according to functions of the electronic device 310. For example, the display 1106 may display at least one of various pieces of service information, media information, text information, or broadcast information according to the execution of the application. According to an example, the display 1106 may perform a screen mirroring operation based on screen mirroring data received from the at least one external device 320.

According to an example, the first communication interface 1108 may include various communication circuitry and perform wired or wireless communication with the at least one external device 320. For example, the first communication interface 1108 may perform wired communication with the at least one external device 320 through a cable or may perform wireless communication based on Wi-Fi, Bluetooth, or other wireless communication technologies.

According to an example, the second communication interface 1110 may include various communication circuitry and perform communication with a remote controller. For example, the second communication interface 1110 may perform IR communication or RF communication with the at least one external device 320.

According to an example, the processor 1102 may include various processing circuitry electrically connected to each of the memory 1104, the display 1106, the first communication interface 1108, and the second communication interface 1110, and may execute at least one instruction of a program stored in the memory 1104. One or more processors 1102 may be provided, and may perform the operations of the electronic device 310 described above. For example, the processor 1102 may perform the example operations described in greater detail below. It will be understood, as set forth above, that the processor 1102 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an example, the processor 1102 may determine whether a first service associated with a first application and requested to be executed in a background satisfies a predetermined condition. The predetermined condition may include a condition in which the electronic device 310 requires communication with the at least one external device 320. The processor 1102 may allocate the first service to a first control group among a plurality of control groups based on the first service satisfying the predetermined condition. The processor 1102 may allocate a resource to the first service based on a first resource allocation ratio corresponding to the first control group. The plurality of control groups may include the first control group, a second control group including a second application executed in a foreground, and a third control group including a third service executed in a background. The first resource allocation ratio may be smaller than a second resource allocation ratio corresponding to the second control group and greater than a third resource allocation ratio corresponding to the third control group.

According to an example, the first application may include at least one application executed to mirror a screen displayed on the at least one external device 320 to the display 1106, and the resource may include a CPU resource.

According to an example, the processor 1102 may receive a connection request for using the first service from the at least one external device 320 through the first communication interface 1108. The processor 1102 may change a control group including the first service from the third control group to the first control group in response to receiving the connection request. The processor 1102 may allocate a resource to the first service based on the first resource allocation ratio corresponding to the first control group and perform connection to the at least one external device 320 based on the allocated resource.

According to an example, the processor 1102 may identify a PID of a process based on the process of the first service being created and invoke a resource allocation boosting API using the identified PID. The processor 1102 may determine whether the first service satisfies the predetermined condition in response to the invocation.

According to an example, the processor 1102 may identify a list of at least one service satisfying the predetermined condition stored in the memory 1104. The processor 1102 may determine whether the first service satisfies the predetermined condition based on the identified list.

According to an example, the processor 1102 may identify whether description information of the first service includes indication information indicating that the first service satisfies the predetermined condition. The processor 1102 may determine whether the first service satisfies the predetermined condition based on whether the indication information is included in the description information.

According to an example, the processor 1102 may perform initialization associated with the first service using the resource allocated to the first service. The processor 1102 may change, upon completion of the initialization, a control group including the first service from the first control group to the third control group.

According to an example, the initialization may include an operation of entering, in response to a request associated with the first application being received from the at least one external device 320, a ready mode capable of processing a request from the at least one external device 320.

According to an example, the processor 1102 may receive, through the second communication interface 1110, a control signal from the remote controller 330 instructing execution of a third application included in the electronic device 310. The processor 1102 may create a process for execution of the third application in response to reception of the control signal and change a control group including the first service from the first control group to the third control group.

[Table 2] below is a table illustrating results of measuring execution performance of a screen mirroring app (e.g., the screen mirroring app 438 of FIG. 4) immediately after cold booting of the electronic device 310.

TABLE 2

| | Without | With |
|---|---|---|
| | Service Boosting | Service Boosting |
| | (sec) | (sec) |
| Detect TV Device (A) | 44.0 | 29.4 |
| Mobile Screen Mirroring (B) | 58.0 | 39.3 |
| Connection Time (B) − (A) | 14.0 | 9.9 |

Referring to [Table 2], the value of the ‘Without Service Boosting’ item indicates a required time according to a conventional technology, and ‘With Service Boosting’ indicates a required time according to various embodiments disclosed in the disclosure.

According to various embodiments, execution of a communication-related service between the electronic device (e.g., TV) 310 and the at least one external device (e.g., mobile terminal) 320 and execution and preparation time of an application based on the service are advanced. For example, a time (A) for the at least one external device 320 to detect the electronic device 310 is decreased from 44.0 seconds to 29.4 seconds.

As the priority of a service (e.g., the communication authenticator 430, the connection information manager 432, or the app executor 434 of FIG. 4) associated with the screen mirroring app is raised compared to before and thus a CPU resource allocation amount is increased, a time (B) required until the electronic device 310 mirrors a screen of the at least one external device 320 is decreased from 58.0 seconds to 39.3 seconds.

As a result, a connection time between the electronic device 310 and the at least one external device 320, which may be determined by a difference between the time (B) and the time (A), is shortened from 14.0 seconds to 9.9 seconds, and thus the screen mirroring app may be executed more quickly.

The electronic device 310 according to various embodiments of the disclosure may be one of various types of electronic devices. The electronic devices 310 may include, for example, a portable communication device (e.g., a smart phone), a computer device, a portable multimedia device, a portable medical device, a camera, a wearable device, a home appliance, or the like. According to an embodiment of the disclosure, the electronic devices 310 are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
memory; and
at least one processor, comprising processing circuitry, electrically connected to the memory and individually and/or collectively configured to execute at least one instruction of at least one program stored in the memory, wherein at least one processor, individually and/or collectively, is configured to cause the electronic device to:
determine whether a first service associated with a first application and requested to be executed in a background satisfies a specified condition,
allocate the first service to a first control group among a plurality of control groups based on the first service satisfying the specified condition, and
allocate a resource to the first service based on a first resource allocation ratio corresponding to the first control group,
wherein the plurality of control groups include the first control group, a second control group including a second application executed in a foreground, and a third control group including a third service executed in the background, and
wherein the first resource allocation ratio is smaller than a second resource allocation ratio corresponding to the second control group and greater than a third resource allocation ratio corresponding to the third control group.

2. The electronic device of claim 1, wherein the specified condition includes a condition requiring communication with at least one external device for execution of the first application.

3. The electronic device of claim 2, further comprising a display,
wherein the first application includes at least one application configured to mirror a screen displayed on the at least one external device to the display, and
wherein the resource includes a central processing unit (CPU) resource.

4. The electronic device of claim 2, further comprising a first communication interface comprising communication circuitry configured to perform communication with the at least one external device, and
wherein at least one processor, individually and/or collectively, is configured to cause the electronic device to:
receive a connection request for using the first service from the at least one external device through the first communication interface;
in response to receiving the connection request, change a control group including the first service from the third control group to the first control group;
allocate a resource to the first service based on the first resource allocation ratio corresponding to the first control group; and
perform connection to the at least one external device based on the allocated resource.

5. The electronic device of claim 1, wherein at least one processor, individually and/or collectively, is configured to cause the electronic device to:
based on a process of the first service being created, identify a process identifier (PID) of the process;
invoke a resource allocation boosting application programming interface (API) using the identified process identifier; and
in response to the invocation, determine whether the first service satisfies the specified condition.

6. The electronic device of claim 1, wherein the memory is configured to store a list of at least one service satisfying the specified condition, and
wherein at least one processor, individually and/or collectively, is configured to cause the electronic device to, based on the list, determine whether the first service satisfies the specified condition.

7. The electronic device of claim 1, wherein at least one processor, individually and/or collectively, is configured to cause the electronic device to:
identify whether description information of the first service includes indication information indicating that the first service satisfies the specified condition; and
based on whether the indication information is included in the description information, determine whether the first service satisfies the specified condition.

8. The electronic device of claim 1, wherein at least one processor, individually and/or collectively, is configured to cause the electronic device to:
perform initialization associated with the first service using the resource allocated to the first service; and
based on completion of the initialization, change a control group including the first service from the first control group to the third control group.

9. The electronic device of claim 8, wherein the initialization includes, based on a request associated with the first application being received from at least one external device, entering a ready mode capable of processing the received request.

10. The electronic device of claim 1, further comprising a second communication interface comprising communication circuitry configured to perform communication with a remote controller configured to control the electronic device, and
wherein at least one processor, individually and/or collectively, is configured to cause the electronic device to:
receive, through the second communication interface, a control signal from the remote controller, the control signal instructing execution of a third application included in the electronic device; and
in response to reception of the control signal, create a process for execution of the third application and change a control group including the first service from the first control group to the third control group.

11. A method for managing a resource by an electronic device, the method comprising:
determining whether a first service associated with a first application and requested to be executed in a background satisfies a specified condition;
allocating, based on the first service satisfying the specified condition, the first service to a first control group among a plurality of control groups; and
allocating a resource to the first service based on a first resource allocation ratio corresponding to the first control group,
wherein the plurality of control groups include the first control group, a second control group including a second application executed in a foreground, and a third control group including a third service executed in the background, and
wherein the first resource allocation ratio is smaller than a second resource allocation ratio corresponding to the second control group and greater than a third resource allocation ratio corresponding to the third control group.

12. The method of claim 11, wherein the specified condition includes a condition requiring communication with at least one external device for execution of the first application.

13. The method of claim 12, wherein the first application includes at least one application configured to mirror a screen displayed on the at least one external device to a display of the electronic device, and
wherein the resource includes a central processing unit (CPU) resource.

14. The method of claim 12, further comprising:
receiving a connection request for using the first service from the at least one external device;
in response to receiving the connection request, changing a control group including the first service from the third control group to the first control group;
allocating a resource to the first service based on the first resource allocation ratio corresponding to the first control group; and
performing connection to the at least one external device based on the allocated resource.

15. The method of claim 11, wherein determining whether the first service satisfies the specified condition includes:
based on a process of the first service being created, identifying a process identifier (PID) of the process;
invoking a resource allocation boosting application programming interface (API) using the identified process identifier; and
in response to the invocation, determining whether the first service satisfies the specified condition.

16. The method of claim 11, wherein determining whether the first service satisfies the specified condition includes, based on a list of at least one service satisfying the specified condition, determining whether the first service satisfies the specified condition.

17. The method of claim 11, wherein determining whether the first service satisfies the specified condition includes:
identifying whether description information of the first service includes indication information indicating that the first service satisfies the specified condition; and
based on whether the indication information is included in the description information, determining whether the first service satisfies the specified condition.

18. The method of claim 11, further comprising:
performing initialization associated with the first service using the resource allocated to the first service, and
based on completion of the initialization, changing a control group including the first service from the first control group to the third control group.

19. The method of claim 18, wherein the initialization includes based on a request associated with the first application being received from at least one external device, entering a ready mode capable of processing the received request.

20. The method of claim 11, further comprising:
receiving, from a remote controller configured to control the electronic device, a control signal instructing execution of a third application included in the electronic device; and
in response to reception of the control signal, creating a process for execution of the third application and changing a control group including the first service from the first control group to the third control group.
